(19) United States
(12) Patent Application Publication
(10) Pub. No.: US 2010/0002701 A1
(43) Pub. Date: Jan. 7, 2010

(54) SYSTEM AND METHOD FOR MEDIA COMMUNICATION THROUGH NETWORK ADDRESS TRANSLATION

(75) Inventors: AN-NAN HSIEH, Tu-Cheng (TW); HAI-BIN SU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen)CO., LTD., Shenzhen City (CN); HON HAI PRECISION INDUSTRY CO., LTD., Tu-Cheng (TW)

(21) Appl. No.: 12/208,015

(22) Filed: Sep. 10, 2008

(30) Foreign Application Priority Data
Jul. 1, 2008 (CN) 200810302477.X

(51) Int. Cl. H04L 12/56

(52) U.S. Cl. 370/392

(57) ABSTRACT

A method for media communication through NAT includes assigning a relay port and sending a command to a media relay server by a soft switch device, amending signaling messages of a caller IP terminal and a callee IP terminal so that media packets of the caller IP terminal and the callee IP terminal are transmitted to the media relay server using the soft switch device, and receiving the media packets on the relay port, recording IP addresses, and establishing corresponding connection of the caller IP terminal and the callee IP terminal for relaying the following media packets as the media relay server.

### BACKGROUND

1. Technical Field

The present invention relates to a system and method for media communication through Network Address Translation.

2. Description of Related Art

Network Address Translation (NAT) refers to a function of translating an IP address when an IP packet is forwarded through a router. In a private network, a private address identified only in the private network is used. For an IP packet forwarded to a public network (a network positioned outside the private network), the NAT translates a private address of the IP packet into a public address, which is unique on the Internet.

A media packet generated from a caller IP terminal (an IP terminal located in a private network) and forwarded to the public network, has its private transmission address replaced by a public address, which is dynamically assigned from the available public addresses through the NAT. A callee IP terminal (an IP terminal located in the public network) can receive the media packet from the caller. However, when the callee tries to return a media packet to the caller, the callee fails because the caller cannot receive the media packet because the addresses of the caller are not routable in the NAT private network. Thus, a call between two IP terminals is not established.

What is needed, therefore, is a system and method for media communication to overcome the above-described shortcoming.

### BRIEF DESCRIPTION OF THE DRAWINGS

FIG. 1 is a block diagram of an embodiment of a media communication system through NAT;

FIG. 2 is a block diagram of a construction of a signaling channel connected between a caller IP terminal and a callee IP terminal; and

FIG. 3 is a block diagram of a construction of relaying media packets between a caller IP terminal and a callee IP terminal through a media relay server.

### DETAILED DESCRIPTION OF THE EMBODIMENT

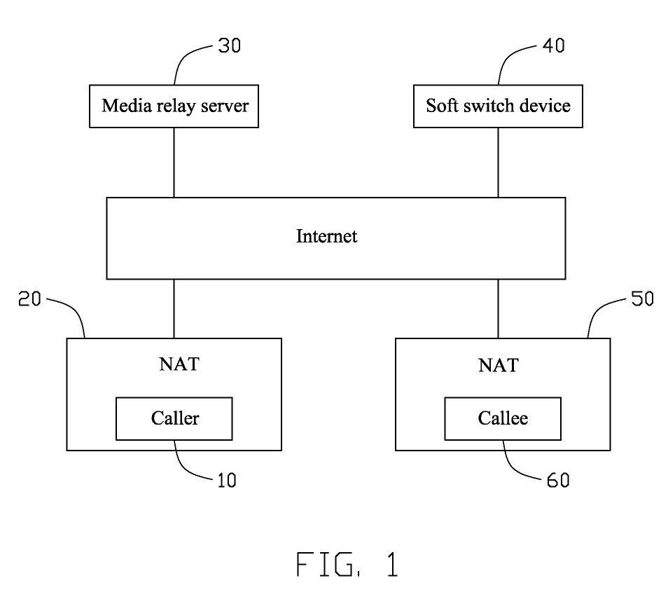

Referring to FIG. 1, a system for media communication includes a caller IP terminal 10, a first NAT router 20 corresponding to the caller IP terminal 10, a media relay server 30, a soft switch device 40, a callee IP terminal 60, and a second NAT router 50 corresponding to the callee IP terminal 60. The caller IP terminal 10 and the callee IP terminal 60 construct a connection among different NAT routers through the media relay server 30 and the soft switch device 40.

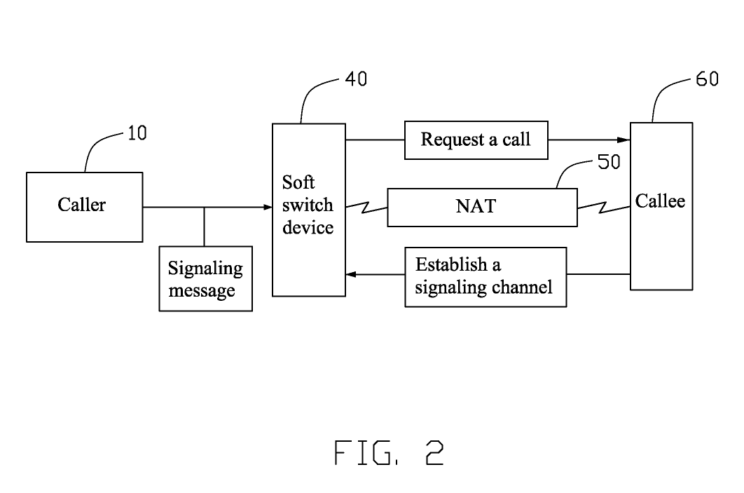

FIG. 2 illustrates a construction of a signaling channel for generating a call between the caller IP terminal 10 and the callee IP terminal 60. The caller IP terminal 10 and the callee IP terminal 60 establish an IP channel with the soft switch device 40, and send identification (ID) to the soft switch device 40. The soft switch device 40 saves the IP channel information (IP addresses and ports) and users' IDs. When the caller IP terminal 10 calls the soft switch device 40, the soft switch device 40 finds the callee IP terminal 60 through the IP channel. If the callee IP terminal 60 is positioned in some other NAT private network, the soft switch device 40 saves signaling messages from the caller IP terminal 10. The soft switch device 40 obtains the IP channel of the callee IP terminal 60 from the stored IP channel information, and then transmits a call request to the callee IP terminal 60. The callee IP terminal 60 receives the call request and establishes a signaling channel with the soft switch device 40.

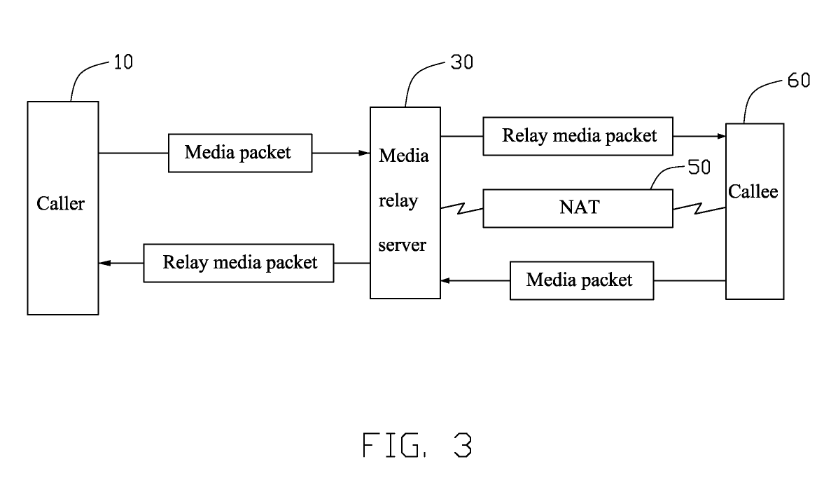

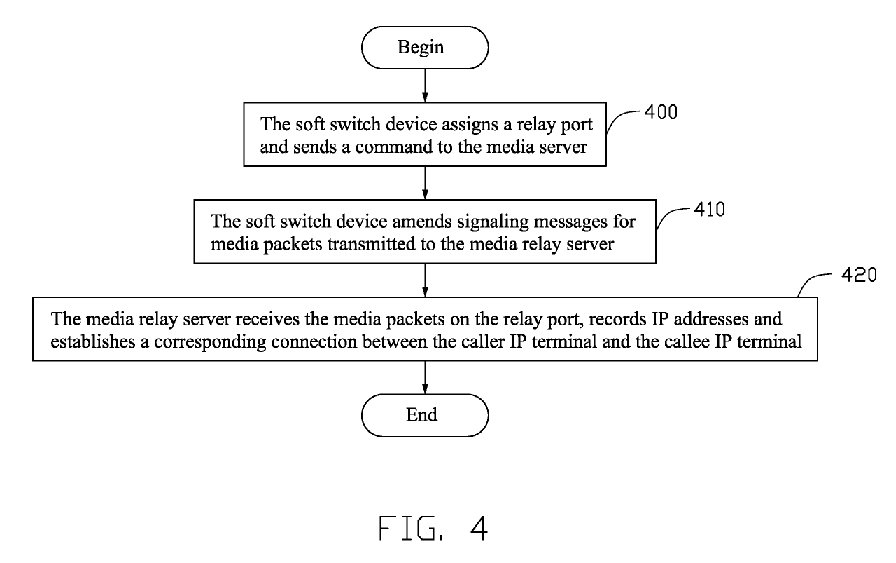

FIG. 3 illustrates a media packet penetrating the NAT private network between the caller IP terminal 10 and the callee IP terminal 60. When the call is generated by the caller IP terminal 10, the soft switch device 40 checks whether a relay service is needed according to configuration data (the caller IP terminal 10 sending configuration data to the soft switch device 40). The soft switch device 40 assigns a relay port and sends a relay port command to the media relay server 30. The media relay server 30 employs the relay port for media packet relay between the caller IP terminal 10 and the callee IP terminal 60. Then, the soft switch device 40 amends the signaling messages of the caller IP terminal 10 and the callee IP terminal 60 so that the media packets of the caller IP terminal 10 and the callee IP terminal 60 are transmitted to the media relay server 30. The media relay server 30 receives the media packets on the relay port, records the IP addresses of the caller IP terminal 10 and the callee IP terminal 60, and establishes a corresponding connection between the caller IP terminal 10 and the callee IP terminal 60. When the media relay server 30 receives the media packet, the media relay server 30 compares the IP address of the media packet with the stored IP addresses and sends the media packet to the appropriate IP address. The media packets may be encrypted.

FIG. 4 illustrates a flow chart of FIG. 3. Depending on the embodiment, certain of the steps described below may be removed, others may be added, and the sequence of steps may be altered.
Step 400: the soft switch device 40 assigns a relay port and sends a command to the media relay server 30 to employ the relay port.
Step 410: the soft switch device 40 amends signaling messages from the caller IP terminal 10 and the callee IP terminal 60 so that media packets from the caller IP terminal 10 and the callee IP terminal 60 are transmitted to the media relay server 30.
Step 420: the media relay server 30 receives the media packets on the relay port, records IP addresses, and establishes a corresponding connection between the caller IP terminal 10 and the callee IP terminal 60 for relaying the media packets.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for media communication through NAT, the method comprising:
assigning a relay port and sending a command to a media relay server to employ the relay port by a soft switch device;
amending signaling messages from a caller IP terminal and a callee IP terminal so that media packets from the caller IP terminal and the callee IP terminal are transmitted to the media relay server using the soft switch device; and
receiving the media packets on the relay port, recording IP addresses, and establishing a corresponding connection between the caller IP terminal and the callee IP terminal for relaying the media packets as the media relay server.

2. The method of claim 1, wherein a signaling channel is established between the caller IP terminal and the callee IP terminal by the soft switch device saving the signaling messages.

3. The method of claim 2, wherein an IP channel is established for the signaling channel between each IP terminal and the soft switch device on an Internet.

4. The method of claim 3, wherein the soft switch device finds the callee IP terminal through the IP channel of the callee IP terminal for requesting to construct the signaling channel.

5. The method of claim 4, wherein the callee IP terminal receives the request and establishes the signaling channel.

6. The method of claim 1, wherein the media packets have been encrypted.

7. A system for media communication through NAT, the system comprising:
a soft switch device capable of assigning a relay port; and
a media relay server capable of receiving a relay port command from the soft switch device to employ the relay port for relaying media packets between a caller IP terminal and a callee IP terminal;
wherein the soft switch device amends signaling messages of the caller IP terminal and the callee IP terminal so that media packets of the caller IP terminal and the callee IP terminal are transmitted to the media relay server; after the media relay server receives the media packets on the relay port, the media relay server records the respective IP address of the caller IP terminal and the callee IP terminal and establishes a corresponding relation; the media relay server finds a destination IP address according to a source IP address and sends the media packets to the destination IP address.

8. The system of claim 7, wherein the soft switch device saves the signaling messages and establishes a signaling channel between the caller IP terminal and the callee IP terminal.

9. The system of claim 8, wherein an IP channel is established for the signaling channel between each IP terminal and the soft switch device on an Internet.

10. The system of claim 9, wherein the soft switch device finds the callee IP terminal through the IP channel of the callee IP terminal for requesting to construct the signaling channel.

11. The system of claim 10, wherein the callee IP terminal receives the request and establishes the signaling channel.

12. The system of claim 7, wherein the media packets have been encrypted.
